(19) United States
(12) Patent Application Publication
(10) Pub. No.: US 2021/0341300 A1
(43) Pub. Date: Nov. 4, 2021

(54) METHOD, APPARATUS, AND SYSTEM FOR PROVIDING A PERSONALLY RELEVANT NAVIGATION ROUTE COMPARISON

(71) Applicant: HERE Global B.V., Eindhoven (NL)

(72) Inventors: Jerome BEAUREPAIRE, Berlin (DE); Stephan KOSMELLA, Berlin (DE)

(21) Appl. No.: 16/866,113

(22) Filed: May 4, 2020

(51) Int. Cl. G01C 21/34; G01C 21/36

(52) U.S. Cl. CPC G01C 21/3446; G01C 21/3605; G01C 21/3641; G01C 21/3492

(57) ABSTRACT

An approach is provided for providing a personally relevant navigation route comparison. The approach involves, for example, determining, by a processor, an optimal navigation route. The approach also involves determining a historical navigation route based on a similarity between the historical navigation route and the optimal navigation route. The approach further involves providing data for presenting one or more of the similarity or a difference between the optimal navigation route and the historical navigation route.

### BACKGROUND

Providing navigation support to users is an important function for map service providers. Current navigation systems can provide users route guidance to and from various locations or points of interest (POIs) such as a restaurant, a sporting or cultural venue, a shopping mall, etc. via various means or modes of transportation (e.g., private transportation, public transportation, shared vehicles, walking, etc.). Many of these systems can also provide an estimated time of arrival (ETA) along with the route guidance and/or compare various ETAs for different routes or transport modes. However, these systems often surface the same routes or modes of transportation for all users. Consequently, users that are unfamiliar with the routes may have difficulty making sense of the estimated times or distances, thereby likely defaulting to habit (e.g., selecting a familiar route or mode of transport). In some cases, by defaulting to habit (e.g., selecting the fastest route), a user may forgo a route that has alternative or additional benefits (e.g., environmental, health, etc.) that the user may find equally if not more personally relevant to route selection. Accordingly, mapping service providers face significant technical challenges to provide a basis for comparing different navigation routes (e.g., unfamiliar routes) in a way that is personally relevant to a user.

### SOME EXAMPLE EMBODIMENTS

Therefore, there is a need for an approach for providing a personally relevant navigation route comparison to enable users to make routing related decisions.

According to one embodiment, a method for providing a comparative analysis of a navigation route comprises determining, by a processor, an optimal navigation route. The method also comprises determining a historical navigation route based on a similarity between the historical navigation route and the optimal navigation route. The method further comprises providing data for presenting one or more of the similarity or a difference between the optimal navigation route and the historical navigation route.

According to another embodiment, an apparatus for providing a comparative analysis of a navigation route comprises at least one processor, and at least one memory including computer program code for one or more computer programs, the at least one memory and the computer program code configured to, with the at least one processor, cause, at least in part, the apparatus to determine, by a processor, an optimal navigation route. The apparatus is also caused to determine a historical navigation route based on a similarity between the historical navigation route and the optimal navigation route. The apparatus is further caused to provide data for presenting one or more of the similarity or a difference between the optimal navigation route and the historical navigation route.

According to another embodiment, a non-transitory computer-readable storage medium for providing a comparative analysis of a navigation route carries one or more sequences of one or more instructions which, when executed by one or more processors, cause, at least in part, an apparatus to determine, by a processor, an optimal navigation route. The apparatus is also caused to determine one or more user accounts associated with the optimal navigation route. The apparatus is further caused to determine a historical navigation route based on a similarity between the historical navigation route and the optimal navigation route, wherein the determining of the historical navigation route is based on the historical navigation route being associated with at least one of the one or more user accounts. The apparatus is further caused to provide data for presenting one or more of the similarity or a difference between the optimal navigation route and the historical navigation route.

According to another embodiment, an apparatus for providing a comparative analysis of a navigation route comprises means for determining, by a processor, an optimal navigation route. The apparatus also comprises means for determining a historical navigation route based on a similarity between the historical navigation route and the optimal navigation route. The apparatus further comprises means for providing data for presenting one or more of the similarity or a difference between the optimal navigation route and the historical navigation route.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a personally relevant navigation route comparison, according to example embodiment(s);

FIG. 2 is a diagram of the components of a mobility platform, according to example embodiment(s);

FIG. 3 is a flowchart of a process for providing a personally relevant navigation route comparison, according to example embodiment(s);

FIGS. 4A through 4C are diagrams of example user interfaces for providing a personally relevant navigation route comparison, according to example embodiment(s);

FIG. 5 is a diagram of a geographic database, according to example embodiment(s);

FIG. 6 is a diagram of hardware that can be used to implement example embodiment(s);

FIG. 7 is a diagram of a chip set that can be used to implement example embodiment(s); and

FIG. 8 is a diagram of a mobile terminal (e.g., handset or vehicle or part thereof) that can be used to implement example embodiment(s).

### DESCRIPTION OF SOME EMBODIMENTS

Examples of a method, apparatus, and computer program for providing a personally relevant navigation route comparison are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

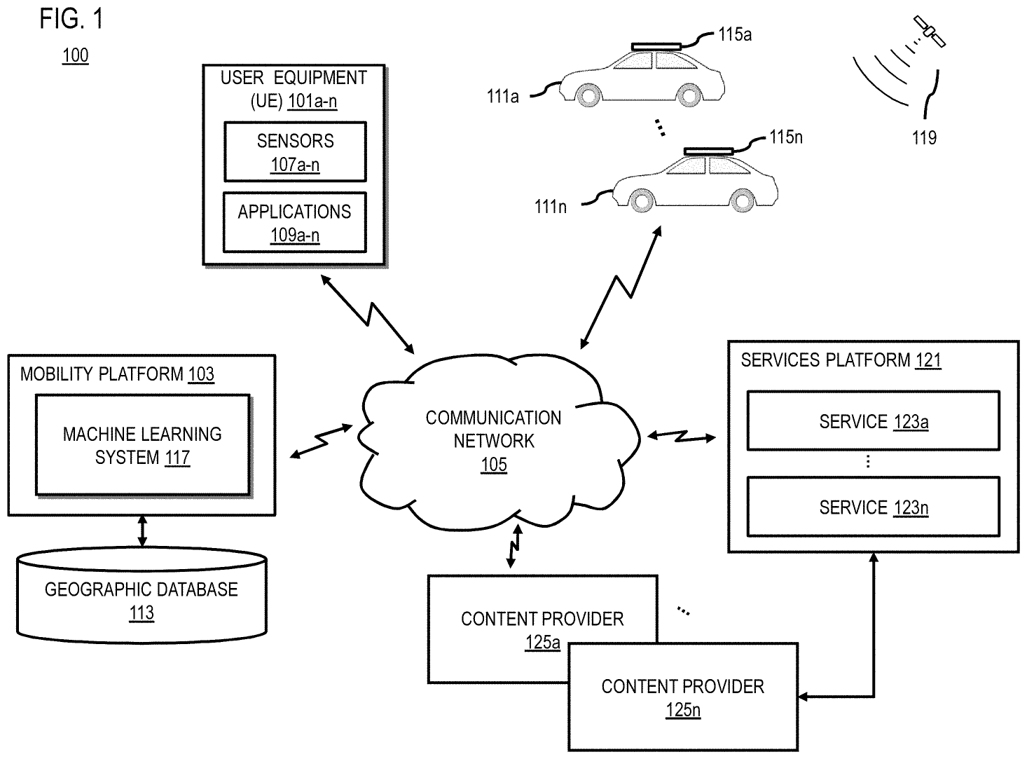

FIG. 1 is a diagram of a system capable of providing a personally relevant navigation route comparison, according to example embodiment(s). As described above, providing navigation support to users is an important function for map service providers. Current navigation systems can provide route guidance (e.g., via a mobile device, an embedded navigation system, etc.) to enable a user to travel between locations (e.g., origin, destination, and/or waypoints) via various means or modes of transportation (e.g., vehicles, public transportation, walking, biking, etc.).

As part of providing route guidance, navigation systems compute and compare different possible routes or modes of transportation using a routing engine. For example, the routing engine generates one or more “optimal” routes based on any number of configured cost functions or metrics (e.g., cost functions based on estimated time of arrival (ETA), distance, mode of transport, road attributes, real-time traffic, user preference, historical user mobility data, etc.). In other words, the optimal route may be a navigation route that minimizes or otherwise factors in the cost functions applied during route computation.

The computed optimal route(s) can then be, for instance, presented to the user. Historically, the presentation of optimal routes can specify the route along with attributes such as ETA, distance, and modes of transport. However, the user may have difficulty making sense of the various ETAs, distances, etc. presented to characterize the optimal routes, particularly when a user is unfamiliar with the presented routes. Moreover, such presentations often do not include attributes such as weather, pollution levels, elevation profile, terrain data, road attributes, cellular coverage levels, among other possibilities that may be relevant or otherwise of personal interest to the user (e.g., in terms of environmental impact, personal health, etc.). This, in turn, can lead to a poor user experience and ultimately dissatisfaction with the corresponding mapping/navigation service. In other words, the user may have cognitive difficulty in translating the traditionally presented metrics of ETAs, distances, etc. when selecting which route to take. This cognitive difficulty is particularly acute when the different routes are more complex and use different modes of transport (e.g., one route option is to walk, another is to drive, and yet another combines both walking and taking public transport). As a result, users may avoid the cognitive difficulty and simply take only familiar routes or only the top-most suggested route, thereby missing out on possible alternative routes (e.g., unfamiliar routes) that may provide a better experience to the user. Accordingly, mapping service providers face significant technical challenges to provide a personally relevant navigation route comparison to enable a user to decide which navigation route to take.

To address these technical problems, a system 100 of FIG. 1 introduces a capability to provide a personally relevant navigation route comparison, according to example embodiment(s). In one embodiment, the system 100 enables users to relevantly compare a computed navigation route (e.g., to a selected destination) with personal and historical routes that the user has already traveled, hence are relatively more familiar. For example, the system 100 can determine the optimal route (or route segment) to refer to in a route comparison (e.g., by using a navigation routing engine). The system 100 can then rank historical routes based on relevance to the computed optimal route. Historical routes, for instance, include but are not limited to routes recorded as previously traveled or known to the user (e.g., a route previously presented to the user). In one embodiment, the system 100 can determine which factors or attributes (e.g., contextual or historical factors or attributes) to use when performing this ranking and comparison. The system 100 then surfaces the optimal route(s) with a relevant description and comparison to one or more of the ranked historical routes. By presenting the comparison of the optimal route to a historical route, the system 100 advantageously makes routes more personal and easier for users to relate to and quickly comprehend to make a routing selection. Consequently, a user can make sense of the computed route beyond simply ETAs and distances and, therefore, potentially make more insightful and wiser route related decisions. For example, more insightful and wiser route related decisions may include selecting a route that is more environmentally friendly and/or a mode of transportation that is less polluting relative to the user's habits (e.g., taking the fastest route).

In an illustrative example use case, a user may request a route to a selected destination (e.g., 2 kilometers (km) away), which at first glance may appear to be far away to walk. Consequently, the user may be likely to default to habit (e.g., by selecting the driving route instead of a walking route). However, if the user were able to compare the computed routes to past journeys and/or insights, the user could make more insightful and/or wiser route related decisions (e.g., taking a more environmentally friendly route, a less polluting transport mode, etc.). For example, the user may have recently enjoyed walking a similar distance around a lake with a friend. Thus, the user may be encouraged to walk to the selected destination (e.g., 2 km away) rather than driving, thereby taking a less polluting mode of transportation.

In one embodiment, the system 100 of FIG. 1 may include one or more user equipment (UE) 101a-101n (also collectively referred to herein as UEs 101) (e.g., a mobile device, a smartphone, etc.) having connectivity to a mobility platform 103 via the communication network 105. In one embodiment, the UEs 101 include one or more device sensors 107a-107n (also collectively referred to herein as device sensors 107) (e.g., GPS sensors) and one or more applications 109a-109n (also collectively referred to herein as applications 109) (e.g., a navigation application, a mapping application, etc.). In one instance, a UE 101 (e.g., a mobile device) and/or an application 109 (e.g., a navigation application) can enable a user to request a route or route guidance to a selected destination (e.g., a restaurant). In one embodiment, the destination is unknown to the user (e.g., a new restaurant), hence the request for route guidance. In one instance, the destination may be known to the user (e.g., a place of employment); however, the user wants explore a new route or new route segments, try a new mode of transportation (e.g., a bike versus a bus), or a new combination of routes and/or modes of transportation (e.g., walking to a shared bike dock and then biking to work), etc.

In one embodiment, the system 100 computes routes/route segments (e.g., optimal routes or candidates for optimal routes) for available transport modes (e.g., using any routing engine known in the art). In one instance, routes for available transport modes may include at least one of walking, private or shared vehicles (e.g., cars, bikes, scooters, etc.); autonomous, semi-autonomous, highly-automated driving (HAD) vehicles; and/or public transportation (e.g., buses, metros, subways, trolleys, etc.), among other possibilities. In one instance, the system 100 can also compute intermodal/multimodal routes and/or route segments (e.g., combined walking and public transport routes, combined private and shared vehicles, etc.).

In one embodiment, the system 100 may determine routes and/or available modes of transport by processing probe data from the UEs 101, one or more vehicles 111a-111n (e.g., also collectively referred to herein as vehicles 111) (e.g., standard vehicles, autonomous vehicles, HAD vehicles, semi-autonomous vehicles, etc.). In one embodiment, the vehicles 111 include one or more vehicle sensors 115a-115n (also collectively referred to as vehicle sensors 115) (e.g., GPS sensors) and have connectivity to the mobile platform 103 via the communication network 105. In one embodiment, the probe data may be reported as probe points, which are individual data records collected at a point in time that records telemetry data for that point in time. A probe point can include attributes such as: (1) probe ID, (2) longitude, (3) latitude, (4) heading, (5) speed, and (6) time.

In one embodiment, the system 100 determines an optimal navigation route from among the computed navigation routes for available transport modes. In one instance, the optimal navigation route is the route that the system 100 suggests or encourages the user to take for a cost function or parameter. By way of example, one example cost function/parameter may be based on computing that the optimal navigation route is a more environmentally friendly route (e.g., promotes a more environmentally friendly mode of transport), a more familiar route, a less polluting mode of transportation, or a combination there relative to the other computed routes. In one instance, the cost function or parameter may be used to encourage the user to walk to the selected destination rather taking a vehicle, using public transportation rather than taking a private vehicle, carpooling rather than driving alone, etc.

In one embodiment, the system 100 analyzes a user's historical journey or travel data (e.g., historical route data) to determine the most relevant historical route among the user's historical routes relative to the optimal computed navigation route. In one embodiment, wherein the system 100 is unable to access a user's historical data, the system could analyze generic route or reference data (e.g., the length of a soccer field) to determine a relevant route reference. In one instance, the system 100 starts searching the user's historical journey or travel data (e.g., stored in or accessed via the geographic database 113) based on the system 100's determination of a user's familiarity with the computed navigation routes. For example, if the system 100 determines that the user's familiarity with the optimal computed navigation route is below a threshold familiarity index level, then the system 100 will start searching the user's historical journey data for one or more historical journeys or travels (e.g., a mobility graph) to enable the user to relatively compare the optimal computed navigation route. In one embodiment, the system 100 determines a familiarity index level based on how frequently a user has traveled the optimal computed navigation route or one or more portions thereof. In one instance, the system 100 uses a decay function to slowly forget a route that the user no longer travels and/or has not traveled for some time (e.g., a week, a month, etc.).

In one embodiment, the system 100 determines the user's most relevant historical route by ranking the historical routes based on the number or degree of similarities shared among the computed navigation routes, the optimal computed navigation route, and/or the historical routes. In one instance, the system 100 ranks all the user's historical routes (e.g., using the machine learning system 117). Alternatively or in addition, the system 100 may only rank a certain number of the user's historical routes (e.g., to minimize computational resources). By way of example, the certain number may be based on the historical routes sharing at least a certain number or a certain type of similarities with the computed navigation routes and/or the optimal computed navigation route.

In one instance, the system 100 determines the applicable factors and attributes (i.e., inputs) for ranking the historical routes based on relevance to the optimal computed navigation route. In one embodiment, the factors and attributes may be stored in or accessible via the geographic database 113. By way of example, the applicable factors and attributes may include one or more of the following:
Start and destination
Route+transport mode (car, walk, public transport, etc.)
Historical travel data for the user
Health related information
Terrain data/topology
Road attributes
Weather
Population model (historical+prediction)
Traffic data
Cellular coverage
Any relevant contextual information, etc.
   This list of applicable factors and attributes is provided by way of illustration and not as a limitation.

In one embodiment, once the system 100 determines the one or more applicable factors and attributes for ranking the historical routes, the system 100 determines the corresponding information or data from the historical routes, the computed navigation routes, and/or the optimal computed navigation route (e.g., stored in or accessible via the geographic database 113). In one instance, the 100 can determine the corresponding information or data based on one or more of the following questions:
Do the routes have similar length? How different are they in length?
Do the routes compare in terms of when they happen in the day/week/year (e.g., early morning routes versus a late evening walk)?
Do the routes have similar route attributes?
   For walking, this can be % of walking in a city versus % of walking in a park
   For public transportation routes, this can be the number of changes or transfers required and the total walking distance to and from public transportation hubs
Do the routes have similar elevation profiles (e.g., flat versus hilly)?
Do the routes pass similar POIs or natural features (e.g., lakes, historical buildings, restaurants, coffee shops, etc.)?
Do the routes have comparable quietness/peacefulness levels
Do the routes have comparable weather
When the did the historical travel or journey happen or occur

In one embodiment, wherein the system 100 determines that an available transportation mode includes an autonomous vehicle (e.g., a vehicle 111), the system 100 can also relevantly compare the routes based on whether the respective routes would enable a user to perform one or more similar activities within the autonomous vehicle during the journey. For example, would the routes enable a user to watch a television show or a movie, read a chapter of a book, drink a cup of coffee or tea, eat a fast food or take away meal, etc. it is contemplated that the system 100 could compare any activities that can be safely performed in an autonomous vehicle during a journey.

In one embodiment, the system 100 ranks the user's historical routes based on all information and data corresponding to the respective routes being weighted evenly. Alternatively or in addition, the system 100 can independently weight various information and data corresponding to the restive routes. For example, the system 100 can determine in one instance that certain information or data (e.g., route length) should be weighted relatively more in connection with the ranking (e.g., route length versus route weather). In one embodiment, the system 100 can store the applicable factors and attributes, questions, and/or respective weights or weighting schemes corresponding to a user in the geographic database 113 as labeled or marked features for future use and/or training of the machine learning system 117 to improve the speed and accuracy of the system 100's ranking and/or comparison process.

In one instance, the system 100 can weight or emphasize the information and data corresponding to the date of the user's historical journey or travels by using a decay function to reduce the rank of a historical route relative to the amount of time elapsed between the optimal computed navigation route and the historical route. By way of example, the system 100 can use the decay function to account for the observation that users often quickly forget journeys or travels that occurred a few weeks or months ago and, therefore, such routes may not be of much use to enable the user to make sense of the optimal computed route. In one embodiment, the system 100 can weight or emphasize attributes such as route length and elevation (e.g., where a user is comparing routes for outdoor activities such as running and hiking) to encourage users to discover new routes which are similar to or are some percentage longer, harder, steeper, etc. than a user's historical comparable routes (e.g., running and hiking routes).

In one embodiment, the system 100 surfaces (e.g., via a UE 101 and/or an application 109) a description or explanation of the correlation between the most relevant historical route (i.e., highest ranked) and the optimal computed navigation route. In one instance, the system 100 can surface the description or explanation as a human readable explanation (e.g., “this route is only 200 meters (m) longer than the route you walked last Sunday through the park,” or “this is route is similar in length and time to your general walking commute to work,” etc.). In one embodiment, the system 100 can surface the description and explanation as a visual or graphic comparison such that the optimal computed navigation route and the most relevant historical route are rendered side-by-side or as an overlay (e.g., one route being visible in the background and the other one as an overlay so that the user can quickly compare the two). In one embodiment, the system 100 can surface the description or explanation in an audible form (e.g., “the optimal route includes 1.8 km of walking, which is similar to yesterday's walk to the concert hall”). In one instance, the system 100 can also determine whether someone and/or who was traveling with the user during a historical route such that it can later surface that information along with the description or explanation (e.g., “this route is similar in length and duration to the one you took 2 weeks ago with Marc”).

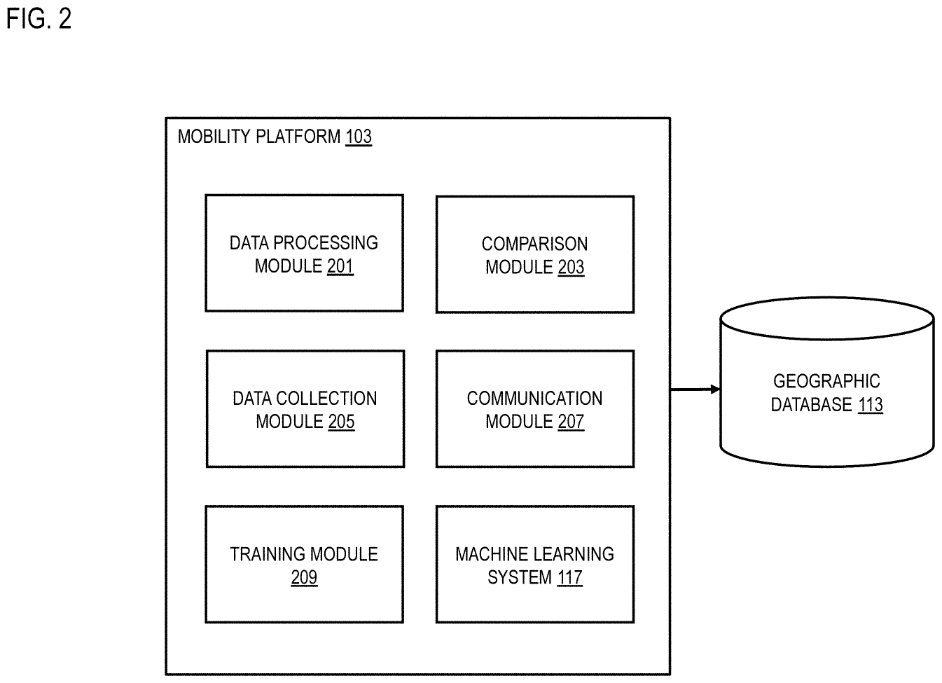

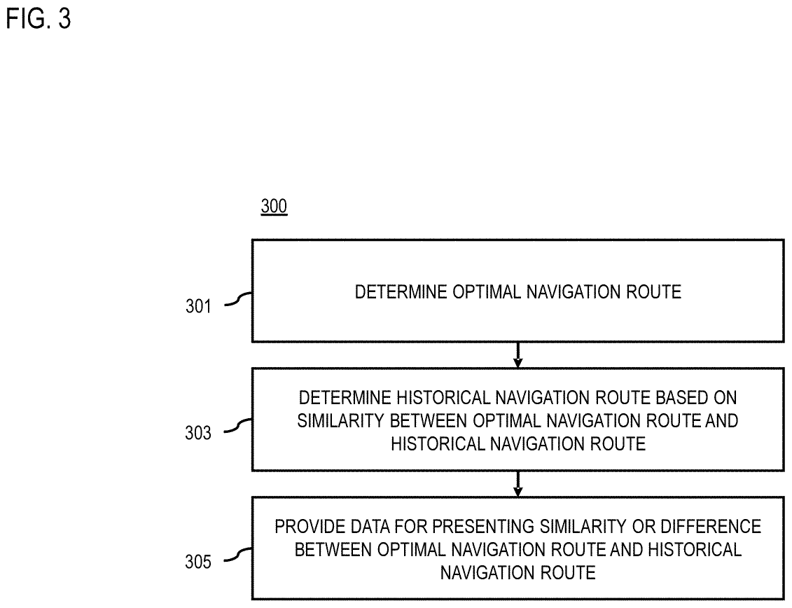

FIG. 2 is a diagram of the components of the mobility platform 103, according to example embodiment(s). By way of example, the mobility platform 103 includes one or more components for providing a personally relevant navigation route comparison, according to the various embodiments described herein. It is contemplated that the functions of these components may be combined or performed by other components of equivalent functionality. In one embodiment, the mobility platform 103 includes an data processing module 201, a comparison module 203, a data collection module 205, a communication module 207, a training module 209, and the machine learning system 117, and has connectivity to the geographic database 113. The above presented modules and components of the mobility platform 103 can be implemented in hardware, firmware, software, or a combination thereof. Though depicted as a separate entity in FIG. 1, it is contemplated that the mobility platform 103 may be implemented as a module of any other component of the system 100. In another embodiment, the mobility platform 103 and/or the modules 201-209 may be implemented as a cloud-based service, local service, native application, or combination thereof. The functions of the mobility platform 103, the machine learning system 117, and/or the modules 201-209 are discussed with respect to FIG. 3.

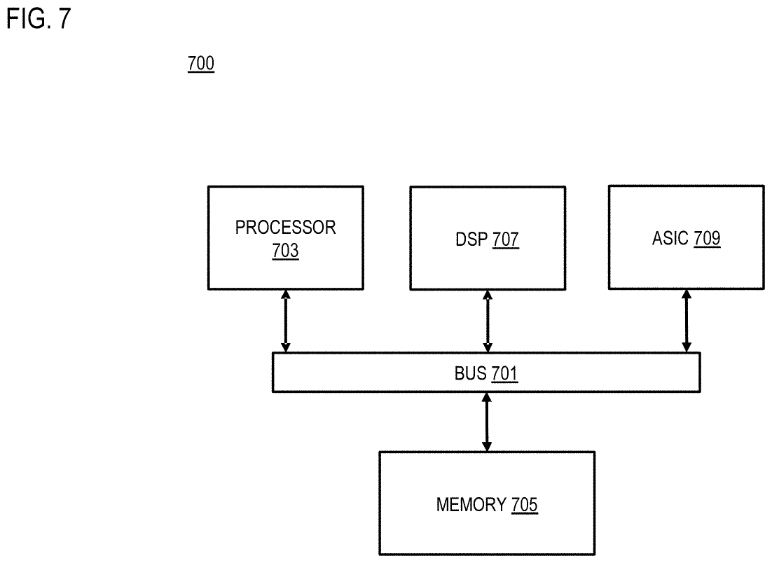

FIG. 3 is a flowchart of a process for providing a personally relative contextual route comparison, according to example embodiment(s). In various embodiments, the mobility platform 103, the machine learning system 117, and/or any of the modules 201-209 may perform one or more portions of the process 300 and may be implemented in, for instance, a chip set including a processor and a memory as shown in FIG. 7. As such, the mobility platform 103, the machine learning system 117, and/or the modules 201-209 can provide means for accomplishing various parts of the process 300, as well as means for accomplishing embodiments of other processes described herein in conjunction with other components of the system 100. Although the process 300 is illustrated and described as a sequence of steps, its contemplated that various embodiments of the process 300 may be performed in any order or combination and need not include all the illustrated steps.

In step 301, the data processing module 201 determines, by a processor, an optimal navigation route. In one instance, the processor executes a routing engine of a navigation system (e.g., the mobility platform 103). In one embodiment, the data processing module 201 first determines all navigation routes to a selected destination (e.g., a restaurant) for all available transport modes. The data processing module 201 can determine the optimal navigation route from among the computed navigation routes for all available transport modes. By way of example, the data processing module 201 can determine that a computed navigation route is the optimal navigation route for any feasible reason and in any feasible manner. In one instance, the data processing module 201 can determine that a computed navigation route is the optimal navigation route because relative to the other navigation routes it is more environmentally friendly, is a less polluting mode of transportation, or a combination thereof. In one instance, the data processing module 201 can determine that a navigation route is the optimal navigation route if it involves walking to the selected destination rather taking a vehicle, using public transportation rather than taking a private vehicle, carpooling rather than driving alone, etc.

In step 303, the comparison module 203 in connection with the data collection module 205 determines a historical navigation route based on a similarity between the historical navigation route and the optimal navigation route. In one embodiment, the data collection module 205 determines or collects a user's historical journey or travel data (i.e., historical navigation route data). In one instance, the data collection module 205 collects a user's historical journey or travel data from information or data stored in or accessible via the geographic database 113. Alternatively or in addition, in one embodiment, the data collection module 205 determines a user's historical journey or travel data by processing probe data from a UE 101, a vehicle 111, or a combination thereof associated with the user. In one embodiment, probe data may be reported as probe points, which are individual records collected at a point in time that record telemetry data for that point in time. A probe point may include the following five attributes (by way of illustration and not limitation): (1) probe ID; (2) longitude; (3) latitude; (4) speed; and (5) time. In one embodiment, the data processing module 201 can split the plurality of probe points per UE 101, vehicle 111, or a combination thereof based on the unique probe IDs to represent the user's travel trajectory or path (e.g., speed and heading) for each UE 101, vehicle 111, or a combination thereof.

In one embodiment, the comparison module 203 compares each of the user's historical navigation routes against the optimal navigation to determine the similarity between the respective routes. In one instance, the determining of the historical navigation route involves the comparison module 203 selecting the historical navigation route from among a plurality of historical navigation routes that have respective similarities to the optimal navigation route. In one instance, the comparison module 203 determines the similarity based on a travel distance, a travel time, or a combination thereof respectively corresponding to the historical navigation routes and the optimal navigation route.

In one embodiment, the data collection module 205 determines a route attribute, a contextual attribute, or a combination thereof associated with the optimal navigation route, the historical navigation routes, or a combination thereof, wherein the similarity is based on the route attribute, the contextual attribute, or a combination thereof by the comparison module 203. By way of example, the route attribute may include any route related factor or attribute such as a length attribute, an elevation profile attribute, a point-of-interest attribute, or a combination thereof. By way of further example, the contextual attribute may include any contextually related factor or attribute such as a temporal attribute, a user activity attribute, a weather attribute, a noise level attribute, or a combination thereof.

In one embodiment, the training module 209 in connection with the machine learning system 117 selects respective weights of the route attribute, the contextual attribute, or a combination thereof (e.g., determined by the data collection module 205), wherein the similarity is based by the comparison module 203 on the respective weights. In one embodiment, the training module 209 can train the machine learning system 117 to select or assign respective weights, correlations, relationships, etc. among the route attributes, the contextual attributes, or a combination thereof based, for example, on whether a user ultimately takes the optimal navigation route to a selected destination. In one instance, the training module 209 can continuously provide and/or update a machine learning module (e.g., a support vector machine (SVM), neural network, decision tree, etc.) of the machine learning system 117 during training using, for instance, supervised deep convolution networks or equivalents. In other words, the training module 209 trains a machine learning model using the respective weights of the route attributes, the contextual attributes, or a combination thereof to most efficiently select the most relevant historical navigation route and/or improve the likelihood that a user ultimately selects the optimal navigation route to the selected destination. In one embodiment, wherein the similarity is based on the respective weights, the weights are respectively determined (e.g., by the training module 209) for the plurality of historical navigation routes according to an amount of time between each of the plurality of historical navigation routes and the optimal navigation route. In other words, the training module 209 can apply a decay function to the plurality of historical navigation routes such that more recent historical navigation routes are more likely to be determined to be the historical navigation route (e.g., by the comparison module 203) relative to less recent historical navigation routes.

In one embodiment, the data collection module 205 determines one or more user accounts associated with the optimal navigation route, wherein determining the historical navigation route is based on the historical navigation route being associated with at least one of the one or more user accounts. By way of example, the user account information can enable the data collection module 205 to determine which plurality of historical navigation routes among all historical navigation routes (e.g., stored in or accessible via the geographic database 113) the comparison module 203 is to determine the historical navigation route (i.e., the route for comparison).

In step 305, the communication module 207 provides data for presenting one or more of the similarity or a difference between the optimal navigation route and the historical navigation route. In one embodiment, the one or more of the similarity or the difference is presented in a user interface (e.g., a UE 101) of the navigation system (e.g., the system 100). By way of example, the presentation of the one or more similarities or the difference can make the optimal navigation route more personal and easier for the user to relate to, thereby making it more likely that the user will take the optimal navigation route to the selected destination. In one instance, rather than presenting the data to a user (e.g., via a UE 101 such as a mobile device), the communication module 207 can present the data to an autonomous vehicle (e.g., via a UE 101 such as an embedded navigation system). In that instance, the autonomous vehicle 111 can follow the optimal navigation route without driver or occupant input (e.g., via one or more vehicle sensors 115).

In one embodiment, the communication module 207 generates a human readable routing message (e.g., text-based message) indicating the similarity, the difference, the historical navigation route, or a combination thereof, wherein the presenting includes presenting the human readable routing message. By way of example, the human readable routing message may include an explanation or description as to why or how the historical navigation route was selected by the comparison module 203 for comparison (e.g., “this route is only 200 m longer than the route you walked last Sunday through the park” or “this is route is similar in length and time to your general walking commute to work,” etc.). In one instance, the communication module 207 generates a visual representation, an audio representation, or a combination thereof indicating the similarity, the difference, the historical navigation route, or a combination thereof, wherein the presenting includes presenting the visual representation, the audio representation, or the combination thereof. By way of example, the visual representation may include a side-by-side or overlay representation of the historical navigation route and the optimal navigation route (e.g., via an application 109). By way of a further example, the audio representation may include the description or explanation in an audible form (e.g., “the optimal route includes 1.8 km of walking, which is similar to yesterday's walk to the concert hall”).

In one embodiment, the comparison module 203 can determine an additional similarity or an additional difference between the optimal navigation route and the historical navigation route. In one instance, the additional similarity is different from the similarity used by the comparison module 203 as the basis to determine the historical navigation route. By way of example, the comparison module 203 can use the respective travel distances and/or travel times for determining the historical navigation route because those factors may be important to the user (e.g., based on information stored in or accessible via the geographic database 113). But there may happen to be additional similarities, such as a similar elevation, pollution level, etc. based, for example, on one or more user preferences (e.g., stored in or accessible via the geographic database 113) or one or more assigned weights determined by the training module 209 that may still be useful for comparing different navigation routes (e.g., unfamiliar routes) and, therefore, presented to the user even though they were not factors in the process of determining the historical navigation route. In one embodiment, the communication module 207 provides the other data for presenting the additional similarity or the additional difference to a user via a UE 101 (e.g., a mobile device) and/or an application 109 (e.g., a navigation application) and/or to a vehicle 111 (e.g., an autonomous vehicle) via a UE 101 (e.g., an embedded navigation system).

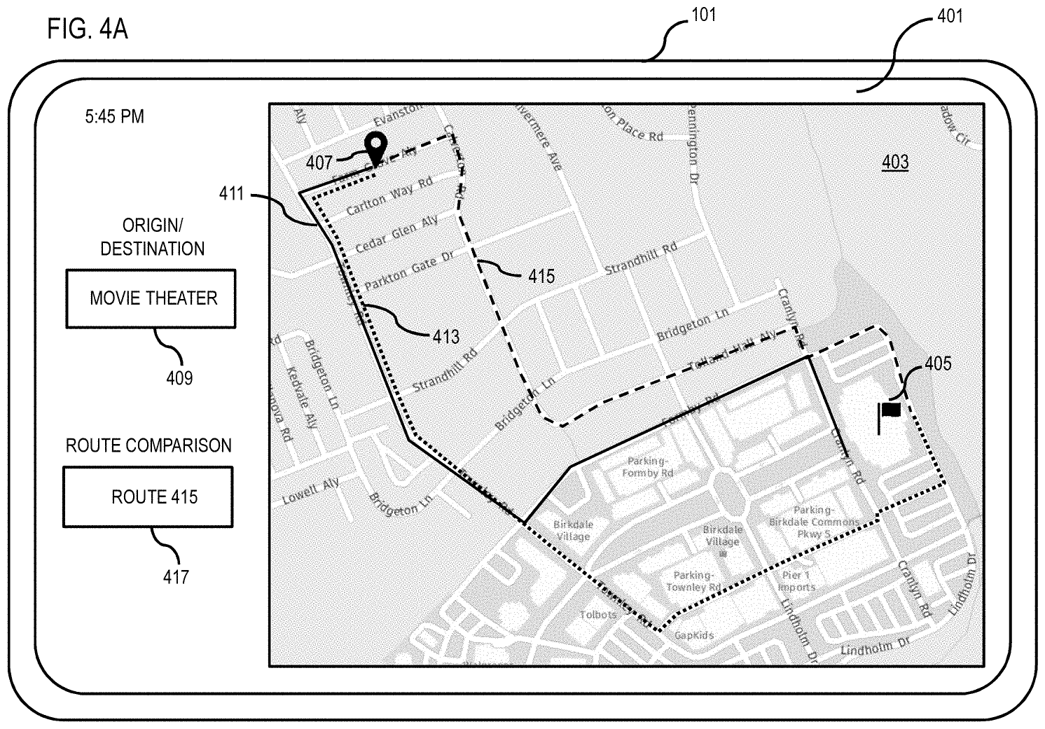

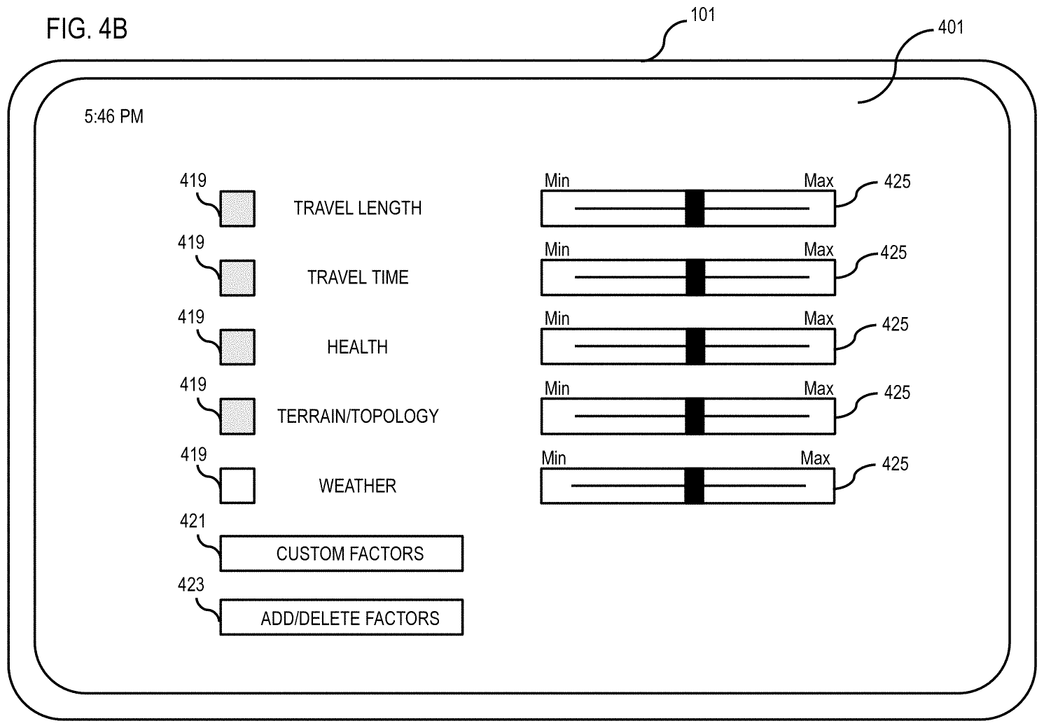

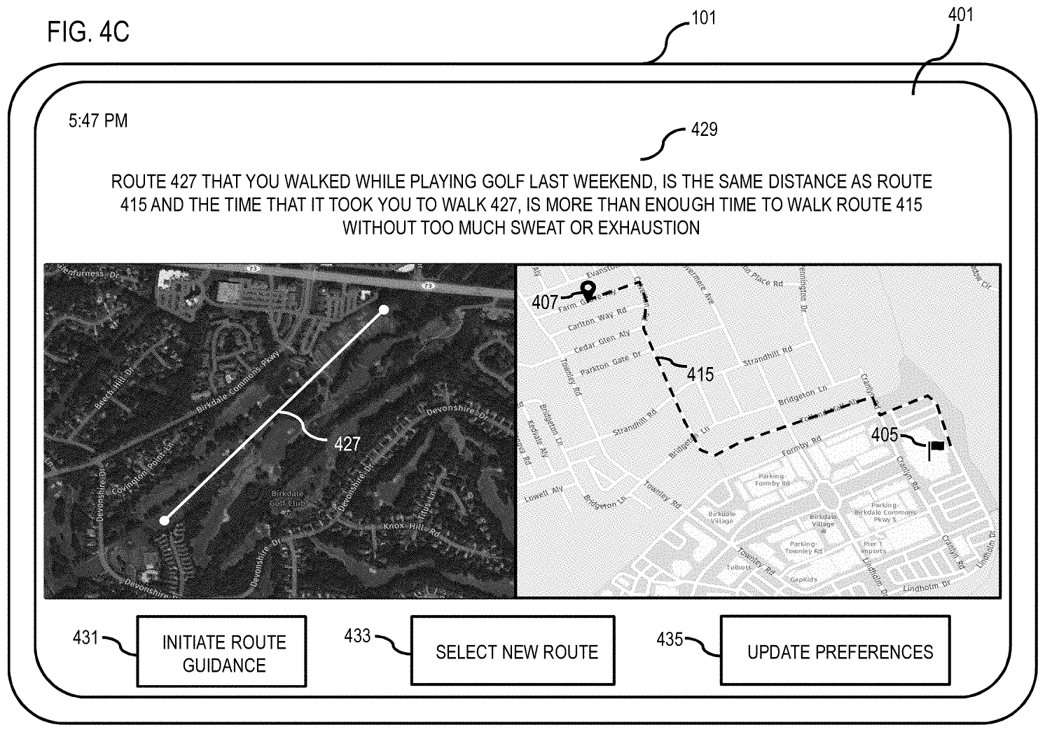

FIGS. 4A through 4C are diagrams of example user interfaces capable of providing a personally relevant navigation route comparison, according to example embodiment(s). Referring to FIG. 4A, in one embodiment, the system 100 generates a user interface (UI) 401 (e.g., a navigation application 109) for a UE 101 (e.g., a mobile device, an embedded navigation system, etc.) that can enable a user to easily make sense of one or more computed navigation routes to a selected destination.

In this example, a user may have recently moved to a given area (e.g., an outdoor living and shopping village) as shown in the map 403 of the UI 401 and wants to travel to a destination 405 (e.g., a movie theater) from her current location 407 (e.g., her home) to watch a movie in the near future. In this example, the user's current location 407 and the destination 405 are slightly less than a km away (i.e., within ordinary walking distance). In this example, at the time of the destination 405 selection (e.g., 5:45 PM or rush hour), there is historically a high volume of vehicle 111 traffic in the area and/or finding parking at or about the time of the movie (e.g., 6:00 PM) is often a challenge. As such, the UI 401 can help the user to decide whether to take a vehicle 111 (e.g., a private vehicle, a shared vehicle, an autonomous vehicle), a bike 111 (e.g., a private bike or a shared bike), or to walk to the destination 405 to arrive on time for the movie.

In one embodiment, the system 100 generates the UI 401 such that it includes an input 407 to enable a user to input an origin and/or a destination (e.g., the movie theater 405, the current location 407, etc.) into the system 100 so that the system 100 can compute routes (e.g., routes 411, 413, and 415) for all available transport modes between the user's current location 407 (e.g., the user's home) and the destination 405 (e.g., the movie theater). In one instance, the user can interact with the input 409 via one or more physical interactions (e.g., a touch, a tap, a gesture, typing, etc.), one or more voice commands (e.g., “I want to go to the movie theater 405”), or a combination thereof. In one embodiment, if the system 100 can access a user's calendar information or data (e.g., with the user's permission) and a POI database (e.g., the geographic database 113), the system 100 can automatically compute relevant routes based on the user's current location without prior user interaction. In one instance, the system 100 can automatically detect the user's current location 407 based on one or more device sensors 107, one or more vehicle vehicles sensors 115, or a combination thereof (e.g., GPS sensors). In this example, the user interacts with the input 409 by typing or saying, “movie theater.” Consequently, the system 100 computes routes for all available transport modes (e.g., routes 411, 413, and 415) between the user's current location 407 and the destination 405. In one instance, the system 100 can simultaneously render the routes 411, 413, and 415 in the UI 401 and can compute and render the respective ETAs (not shown for illustrative convenience).

In this example, the system 100 computes and renders route 411 corresponding to a vehicle 111 route (e.g., taking the user's own vehicle 111), which the system 100 predicts will cause the user to arrive at the destination 405 after the start of the movie (e.g., due to traffic, parking, etc.); route 413 corresponding to a bicycle route (e.g., taking the user's own bicycle), which the system 100 predicts will enable the user to arrive at the movie on time; and route 415 corresponding to a walking route, which the system 100 also predicts will enable the user to arrive at the movie on time. Thus, in this instance, the user wants to determine whether to take the bike route 413 or the walking route 415 since taking the vehicle 411 would cause the user to arrive late for the movie. By way of example, the user may be uncertain whether she wants to bike to and from the movie (e.g., due to low visibility at night, uncertainty of available bike parking, etc.) and she may be similarly uncertain as to whether walking back and forth will require her to expend a significant amount of energy before the movie (e.g., become sweaty and exhausted). In this example, given the fact that both routes 413 and 415 would enable the user to arrive to the destination 405 on time, the user would prefer to walk if she would not become too sweaty or too tired.

In one embodiment, the system 100 generates the UI 401 such that it includes an input 417 (e.g., “route comparison”) to enable a user to initiate the process for providing a personally relevant navigation route comparison as discussed with respect to various embodiments described herein. In this instance, the user wants to have a better sense as to whether walking route 415 to the destination 405 will make her too sweaty or too exhausted. As with input 409, the system 100 can also generate the input 417 such that a user can interact with the input using one or more physical interactions, one or more voice commands, or a combination thereof. In this example, the user interacts the input 417 by typing or saying, “Route 415.” In one embodiment, the system 100 can also automatically generate a relevant route comparison (e.g., for route 415) for any feasible reason to encourage the user to take a particular route (e.g., if the route is more environmentally friendly than other routes, if the route involves a less polluting mode of transportation, etc.).

In one embodiment, the system 100 generates the route comparison based on the user's historical journeys or travels as discussed with respect to the various embodiments described herein. For example, the system 100 can determine the most relevant route (or route segment) to reference for the route comparison based on one or more relevant factors or attributes. Alternatively or in addition, in one embodiment, the system 100 generates the UI 401 such that it includes one or more inputs 419 so that the user may fine tune which factors or attributes the system 100 analyzes when determining the most relevant historic route among the users historic routes to use for the comparative analysis, as depicted in FIG. 4B. In this example, the inputs 419 include factors or attributes such as “travel length,” “travel time,” “health” (e.g., a user's heartrate, sweat rate or perspiration level, eye movement, blood oxygenation, body movement, etc.), “terrain/topology” (e.g., gravel, paved, dirt, grass, elevation, slope, etc.), and “weather” (e.g., rain, sun, snow, wind, temperature, etc.).

In this example, the user interacts with the inputs 419 by selecting all inputs 419 for relative comparison except for the input 419 corresponding to “weather.” For example, the user may contemplate that given the bike route 413 and the walking route 415 both require traveling outside without cover, the weather may not play a significant factor in deciding between the routes 413 and 415. In one embodiment, the system 100 generates the UI 401 such that it includes inputs 421 to enable the user to include one or more custom factors or attributes and input 423 to enable the user to increase or decrease the number of factors or attributes analyzed by the system 100. In one embodiment, the system 100 can also generate the UI 401 such that it includes inputs 425 to enable a user to adjust one or more selected factors or attributes 419 by increasing or decreasing the threshold similarity (e.g., “min” and “max”) when ranking the various historical routes to determine the most relevant route (or route segments) for comparison purposes. As with inputs 409 and 417, the system 100 can also generate the inputs 419, 421, 423, and 425 such that a user can interact with the respective inputs using one or more physical interactions, one or more voice commands, or a combination thereof.

Referring to FIG. 4C, in one embodiment, once the system determines the most relevant historical route (or route segment), the system 100 can surface an audio/visual explanation via the UI 401 as to why a specific historical route was selected for comparison. In this example, the system 100 determined that the user's historical route 427 was the most relevant to route 415 (the route desired by the user if possible) because it was similar in distance, similar in time, similar in slope and/or elevation, and the user's health related information (e.g., heartrate, sweat rate or perspiration level) were all within the user's normal range (i.e., the user wasn't too sweety or too exhausted as a result of the activity). In addition, the system 100 also determined that route 427 consisted of grass whereas route 415 consists of pavement, thereby making it likely that the user can walk easier and/or faster along route 415 than along route 427.

In one embodiment, the system 100 surfaces the audio/visual explanation as a human readable text 429: “Route 427 that you walked while playing golf last weekend, is the same distance as Route 415 and the time that it took you to walk Route 427 is more than enough to walk Route 415 without too much sweat or exhaustion.” Alternatively or in addition, in one embodiment, the system 100 can surface the audio/visual explanation as a visual comparison. By way of example, the visual comparison may include a side by side comparison in the UI 401 and/or an overlay (e.g., one route being visible in the background and the other route being overlaid on top so that user can quickly compare the two routes using various degrees of transparency). In one instance, the system 100 can surface the explanation via the UI 401 in an entirely audible form. In one embodiment, the system 100 can surface each example audio/visual explanation separately or in combination within one another (e.g., based on one or more user preferences stored in or accessible via the geographical database 113).

In one embodiment, the system 100 generates the UI 401 such that it includes an input 431 (e.g., “Initiate Route Guidance”) to enable the user to confirm the selection of a computed navigation route (e.g., route 415) based on the comparison with the historical route (e.g., route 427). In one instance, the system 100 generates the UI 401 such that it includes an input 433 (e.g., “Select New Route”) to enable the user to request another comparison (e.g., one or more other computed navigation routes, one or more other historical routes, or a combination thereof). The system 100 can also generate the UI 401, in one embodiment, such that it includes an input 435 (e.g., “Update Preferences”) to enable the system 100 to update the user's selections and/or preferences (e.g., stored in or accessible via the geographic database 113).

Returning to FIG. 1, in one embodiment, the UEs 101 can be associated with any person (e.g., a pedestrian), any person driving or traveling within a vehicle 111, or with any vehicles 111 (e.g., an embedded navigation system). By way of example, the UEs 101 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles or any combination thereof, including the accessories and peripherals of these devices, or any combination thereof. It is also contemplated that a UE 101 can support any type of interface to the user (such as “wearable” circuitry, etc.). In one embodiment, the vehicles 111 may have cellular or wireless fidelity (Wi-Fi) connection either through the inbuilt communication equipment or from a UE 101 associated with the vehicles 111. Also, the UEs 101 may be configured to access the communication network 105 by way of any known or still developing communication protocols. In one embodiment, the UEs 101 may include the mobility platform 103 to provide a personally relative contextual route comparison.

In one embodiment, the UEs 101 include device sensors 107 (e.g., GPS sensors, a front facing camera, a rear facing camera, multi-axial accelerometers, height sensors, tilt sensors, moisture sensors, pressure sensors, wireless network sensors, etc.) and applications 109 (e.g., mapping applications, navigation applications, shared vehicle booking or reservation applications, public transportation timetable applications, etc.). In one example embodiment, the GPS sensors 107 can enable the UEs 101 to obtain geographic coordinates from satellites 119 for determining current or live location and time. Further, a user location within an area may be determined by a triangulation system such as A-GPS, Cell of Origin, or other location extrapolation technologies when cellular or network signals are available.

In one embodiment, the mobility platform 103 performs the process for providing a personally relevant navigation route comparison as discussed with respect to the various embodiments described herein. In one embodiment, the mobility platform 103 can be a standalone server or a component of another device with connectivity to the communication network 105. For example, the component can be part of an edge computing network where remote computing devices (not shown) are installed along or within proximity of an intended destination (e.g., a city center).

In one embodiment, the machine learning system 117 of the mobility platform 103 includes a neural network or other machine learning system to compare and/or score (e.g., iteratively) a user's historical routes (e.g., travels and/or journeys) against computed navigation routes and/or an optimal computed navigation route. For example, when the inputs are factors and attributes of the respective routes, the output can include a relative ranking or scoring computation as to whether a historical route is the most relevant route (or route segment) to reference for the route comparison analysis. In one embodiment, the machine learning system 117 can iteratively improve the speed by which the system 100 ranks a user's historical routes and/or the likelihood that a user will ultimately select the optimal navigation route to the selected destination. In one embodiment, the neural network of the machine learning system 117 is a traditional convolutional neural network which consists of multiple layers of collections of one or more neurons (which are configured to process a portion of an input data). In one embodiment, the machine learning system 117 also has connectivity or access over the communication network 105 to the geographic database 113 that can store labeled or marked features (e.g., applicable factors and attributes, questions, and/or corresponding information and data, etc.).

In one embodiment, the mobility platform 103 has connectivity over the communications network 105 to the services platform 121 (e.g., an OEM platform) that provides one or more services 123a-123n (also collectively referred to herein as services 123) (e.g., navigation/routing services). By way of example, the services 123 may also be other third-party services and include mapping services, navigation services, traffic incident services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services platform 121 uses the output (e.g. route ranking data, mobility graph data, etc.) of the mobility platform 103 to provide services such as navigation, mapping, other location-based services, etc.

In one embodiment, one or more content providers 125a-125n (also collectively referred to herein as content providers 125) may provide content or data (e.g., including road attributes, terrain data/topology, historical travel data for a user, health related information, weather, population models, traffic data, cellular coverage data, any relevant contextual information, etc.) to the UEs 101, the mobility platform 103, the applications 109, the vehicles 111, the geographic database 113, the services platform 121, and the services 123. The content provided may be any type of content, such as map content, text-based content, audio content, video content, image content, etc. In one embodiment, the content providers 125 may provide content regarding movement of a UE 101, a vehicle 111, or a combination thereof on a digital map or link as well as content that may aid in localizing a user path or trajectory on a digital map or link (e.g., to assist with determining road attributes in connection with historical journeys and travels). In one embodiment, the content providers 125 may also store content associated with the mobility platform 103, the vehicles 111, the geographic database 113, the services platform 121, and/or the services 123. In another embodiment, the content providers 125 may manage access to a central repository of data, and offer a consistent, standard interface to data, such as a repository of the geographic database 113.

In one embodiment, as mentioned above, a UE 101 and/or a vehicle 111 may be part of a probe-based system for collecting probe data for computing routes for all available transport modes and/or user historical routes. In one embodiment, each UE 101 and/or vehicle 111 is configured to report probe data as probe points, which are individual data records collected at a point in time that records telemetry data for that point in time. In one embodiment, the probe ID can be permanent or valid for a certain period of time. In one embodiment, the probe ID is cycled, particularly for consumer-sourced data, to protect the privacy of the source.

In one embodiment, a probe point can include attributes such as: (1) probe ID, (2) longitude, (3) latitude, (4) heading, (5) speed, and (6) time. The list of attributes is provided by way of illustration and not limitation. Accordingly, it is contemplated that any combination of these attributes or other attributes may be recorded as a probe point. For example, attributes such as altitude (e.g., for flight capable vehicles or for tracking non-flight vehicles in the altitude domain), tilt, steering angle, wiper activation, etc. can be included and reported for a probe point. In one embodiment, the vehicles 111 may include vehicle sensors 115 for reporting measuring and/or reporting attributes. The attributes can also be any attribute normally collected by an on-board diagnostic (OBD) system of the vehicle 111, and available through an interface to the OBD system (e.g., OBD II interface or other similar interface).

In one embodiment, the probe points can be reported from the UE 101 and/or the vehicle 111 in real-time, in batches, continuously, or at any other frequency requested by the system 100 over, for instance, the communication network 105 for processing by the mobility platform 103. The probe points also can be map matched to specific road links stored in the geographic database 113. In one embodiment, the system 100 (e.g., via the mobility platform 103) generates user or vehicle paths or trajectories from the observed and expected frequency of probe points for an individual probe so that the probe traces represent routes for all available transport modes, user historical routes, or a combination thereof through a given area (e.g., on road, off road, etc.).

In one embodiment, as previously stated, the vehicles 111 are configured with various sensors (e.g., vehicle sensors 115) for generating or collecting probe data, sensor data, related geographic/map data (e.g., routing data), etc. In one embodiment, the sensed data represents sensor data associated with a geographic location or coordinates at which the sensor data was collected (e.g., a latitude and longitude pair). In one embodiment, the probe data (e.g., stored in or accessible via the geographic database 113) includes location probes collected by one or more vehicle sensors 115. By way of example, the vehicle sensors 115 may include a RADAR system, a LiDAR system, global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on a steering wheel of the vehicles 111, switch sensors for determining whether one or more vehicle switches are engaged, and the like. Though depicted as automobiles, it is contemplated the vehicles 111 can be any type of private or shared manned or unmanned vehicle (e.g., cars, trucks, buses, vans, motorcycles, scooters, bicycles, drones, etc.) that travels through on road/off-road segments of a road network.

Other examples of sensors 115 of a vehicle 111 may include light sensors, orientation sensors augmented with height sensors and acceleration sensor (e.g., an accelerometer can measure acceleration and can be used to determine orientation of the vehicle), tilt sensors to detect the degree of incline or decline of a vehicle 111 along a path of travel, moisture sensors, pressure sensors, etc. In a further example embodiment, vehicle sensors 115 about the perimeter of a vehicle 111 may detect the relative distance of the vehicle 111 from a physical divider, a lane line of a link or roadway, the presence of other vehicles, pedestrians, traffic lights, potholes and any other objects, or a combination thereof. In one scenario, the vehicle sensors 115 may detect weather data, traffic information, or a combination thereof. In one embodiment, a vehicle 111 may include GPS or other satellite-based receivers 115 to obtain geographic coordinates from satellites 119 for determining current location and time. Further, the location can be determined by visual odometry, triangulation systems such as A-GPS, Cell of Origin, or other location extrapolation technologies.

In one embodiment, the UEs 101 may also be configured with various sensors (e.g., device sensors 107) for acquiring and/or generating probe data and/or sensor data associated with a user, a vehicle 111 (e.g., a driver or a passenger), other vehicles, conditions regarding the driving environment or roadway, etc. For example, such sensors 107 may be used as GPS receivers for interacting with the one or more satellites 119 to determine and track the current speed, position and location of a user or a vehicle 111 travelling along a link or on road/off road segment. In addition, the sensors 107 may gather tilt data (e.g., a degree of incline or decline of a vehicle 111 during travel), motion data, light data, sound data, image data, weather data, temporal data and other data associated with the vehicles 111 and/or UEs 101. Still further, the sensors 107 may detect local or transient network and/or wireless signals, such as those transmitted by nearby devices during navigation along a roadway (Li-Fi, near field communication (NFC)) etc.

It is noted therefore that the above described data may be transmitted via the communication network 105 as probe data (e.g., GPS probe data) according to any known wireless communication protocols. For example, each UE 101, application 109, user, and/or vehicle 111 may be assigned a unique probe identifier (probe ID) for use in reporting or transmitting said probe data collected by the vehicles 111 and/or UEs 101. In one embodiment, each vehicle 111 and/or UE 101 is configured to report probe data as probe points, which are individual data records collected at a point in time that records telemetry data.

In one embodiment, the mobility platform 103 retrieves aggregated probe points gathered and/or generated by the device sensors 107 and/or vehicle sensors 115 resulting from the travel of the UEs 101 and/or vehicles 111 on a road segment of a road network or an off segment of a digital map. In one instance, the geographic database 113 stores a plurality of probe points and/or trajectories generated by different UEs 101, device sensors 107, application 109, vehicles 111, vehicle sensors 115, etc. over a period while traveling in a large monitored area (e.g., on road and/or off road). A time sequence of probe points specifies a trajectory—i.e., a path traversed by a UE 101, application 109, vehicle 111, etc. over the period.

In one embodiment, the communication network 105 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the mobility platform 103 may be a platform with multiple interconnected components. The mobility platform 103 may include multiple servers, intelligent networking devices, computing devices, components and corresponding software for providing parametric representations of lane lines. In addition, it is noted that the mobility platform 103 may be a separate entity of the system 100, a part of the services platform 121, a part of the one or more services 123, or included within a vehicle 111 (e.g., an embedded navigation system).

In one embodiment, the geographic database 113 can store information regarding a user's historical journeys or travels (e.g., a mobility graph), historical mobility patterns, route ranking factors and attributes, corresponding information and data, weights and/or weighting schemes, labeled and/or marked features and attributes, user account information, user preferences, POI data (e.g., location data), etc. The information may be any of multiple types of information that can provide means for providing a personally relative contextual route comparison. In another embodiment, the geographic database 113 may be in a cloud and/or in a UE 101, a vehicle 111, or a combination thereof.

By way of example, the UEs 101, mobility platform 103, device sensors 107, applications 109, vehicles 111, vehicle sensors 115, satellites 119, services platform 121, services 123, and/or content providers 125 communicate with each other and other components of the system 100 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

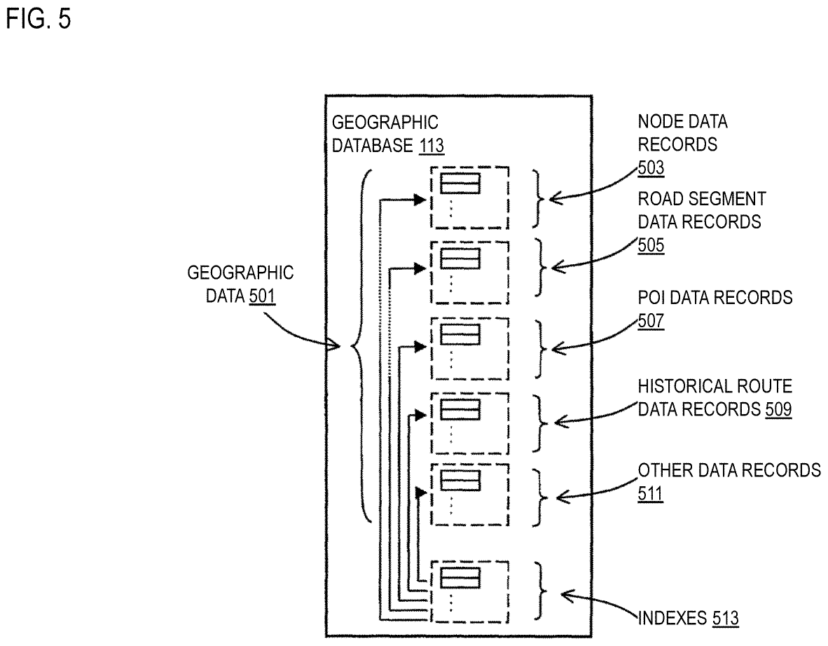

FIG. 5 is a diagram of a geographic database, according to example embodiment(s). In one embodiment, the geographic database 113 includes geographic data 501 used for (or configured to be compiled to be used for) mapping and/or navigation-related services. In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 113.

“Node”—A point that terminates a link.

“Line segment”—A straight line connecting two points.

“Link” (or “edge”)—A contiguous, non-branching string of one or more-line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 113 follows certain conventions. For example, links do not cross themselves and do not cross each other except at a node. Also, there are no duplicated shape points, nodes, or links. Two links that connect each other have a common node. In the geographic database 113, overlapping geographic features are represented by overlapping polygons. When polygons overlap, the boundary of one polygon crosses the boundary of the other polygon. In the geographic database 113, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 113 includes node data records 503, road segment or link data records 505, Point of Interest (POI) data records 507, historical route data records 509, other records 511, and indexes 513, for example. More, fewer or different data records can be provided. In one embodiment, additional data records (not shown) can include cartographic (“cartel”) data records, routing data, and maneuver data. In one embodiment, the indexes 513 may improve the speed of data retrieval operations in the geographic database 113. In one embodiment, the indexes 513 may be used to quickly locate data without having to search every row in the geographic database 113 every time it is accessed. For example, in one embodiment, the indexes 513 can be a spatial index of the polygon points associated with stored feature polygons.

In exemplary embodiments, the road segment data records 505 are links or segments representing roads, streets, or paths, as can be used in the calculated route or recorded route information for determination of one or more personalized routes. The node data records 503 are end points corresponding to the respective links or segments of the road segment data records 505. The road link data records 505 and the node data records 503 represent a road network, such as used by vehicles, cars, and/or other entities. Alternatively, the geographic database 113 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 113 can include data about the POIs and their respective locations in the POI data records 507. The geographic database 113 can also include data about places, such as cities, towns, or other communities, and other geographic features, such as bodies of water, mountain ranges, etc. Such place or feature data can be part of the POI data records 507 or can be associated with POIs or POI data records 507 (such as a data point used for displaying or representing a position of a city).

In one embodiment, the geographic database 113 includes historical route data records 509 for historical journeys or travels (e.g., a mobility graph), historical mobility patterns, route ranking factors and attributes, corresponding information and data, weights or weighting schemes, labeled and/or marked features and attributes, user account information, user preferences, user account data, etc., and/or any other related data. In one embodiment, the historical route data records 509 can be associated with one or more of the node data records 503, road segment or link records 505, and/or POI data records 507; or portions thereof (e.g., smaller or different segments than indicated in the road segment records 505) to provide a personally relative contextual route comparison.

In one embodiment, the geographic database 113 can be maintained by the services platform 121 (e.g., a map developer). The map developer can collect geographic data to generate and enhance the geographic database 113. There can be different ways used by the map developer to collect data. These ways can include obtaining data from other sources, such as municipalities or respective geographic authorities. In addition, the map developer can employ field personnel to travel by vehicle along roads throughout the geographic region to observe features (e.g., road closures or other traffic incidents, etc.) and/or record information about them, for example. Also, remote sensing, such as aerial or satellite photography, can be used.

In one embodiment, the geographic database 113 include high resolution or high definition (HD) mapping data that provide centimeter-level or better accuracy of map features. For example, the geographic database 113 can be based on Light Detection and Ranging (LiDAR) or equivalent technology to collect billions of 3D points and model road surfaces and other map features down to the number lanes and their widths. In one embodiment, the HD mapping data capture and store details such as the slope and curvature of the road, lane markings, roadside objects such as signposts, including what the signage denotes. By way of example, the HD mapping data enable highly automated vehicles to precisely localize themselves on the road, and to determine road attributes (e.g., learned speed limit values) to at high accuracy levels.

In one embodiment, the geographic database 113 is stored as a hierarchical or multilevel tile-based projection or structure. More specifically, in one embodiment, the geographic database 113 may be defined according to a normalized Mercator projection. Other projections may be used. By way of example, the map tile grid of a Mercator or similar projection is a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom or resolution level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grid 10. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one-dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid 10. In one embodiment, the quadkey is an example of the hash or encoding scheme of the respective geographical coordinates of a geographical data point that can be used to identify a tile in which the geographical data point is located.

The geographic database 113 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 111, a vehicle sensor 115 and/or a UE 101. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing a personally relevant navigation route comparison may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

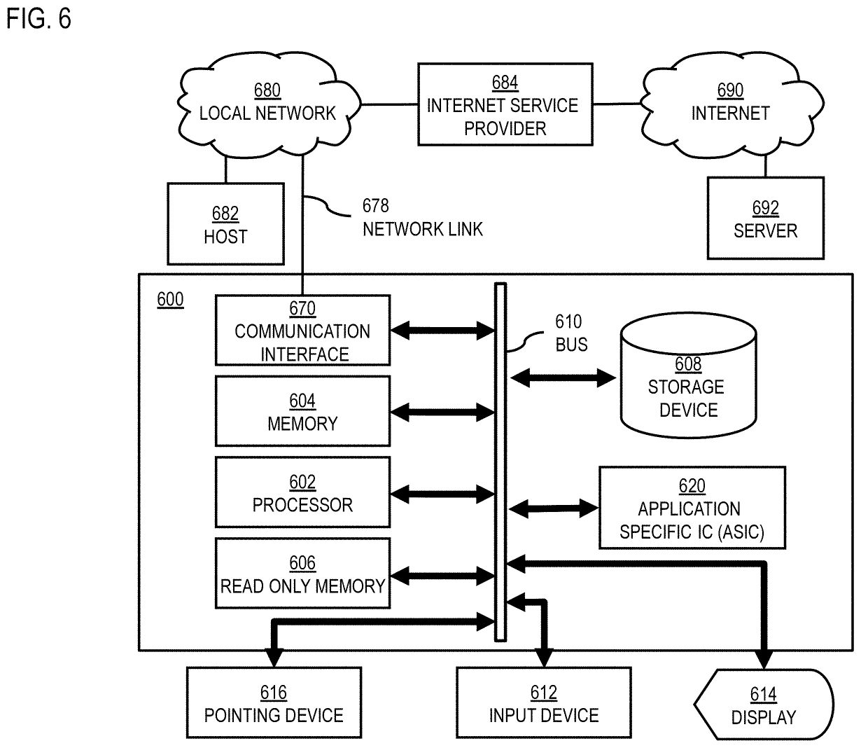

FIG. 6 illustrates a computer system 600 upon which example embodiment(s) of the invention may be implemented. Computer system 600 is programmed (e.g., via computer program code or instructions) to provide a personally relevant navigation route comparison as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to providing a personally relevant navigation route comparison. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for providing a personally relevant navigation route comparison. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for providing a personally relevant navigation route comparison, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general, the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for providing a personally relevant navigation route comparison.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 7 illustrates a chip set 700 upon which example embodiment(s) of the invention may be implemented. Chip set 700 is programmed to provide a personally relevant navigation route comparison as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to provide a personally relevant navigation route comparison. The memory 705 also stores the data associated with or generated by the execution of the inventive steps.

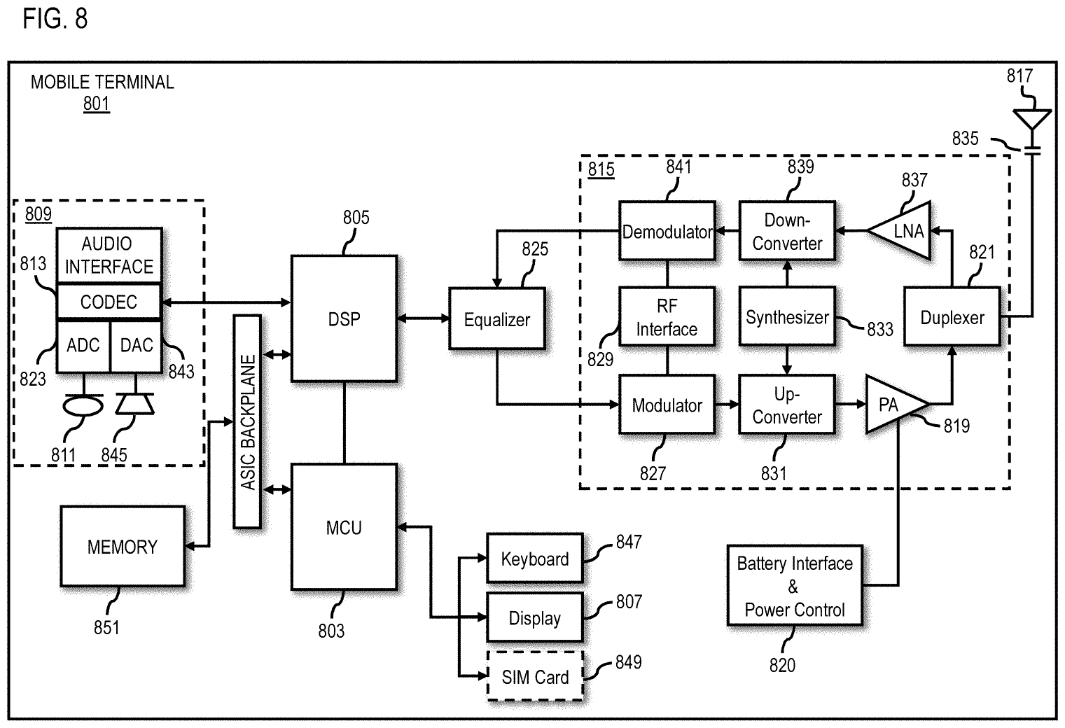

FIG. 8 is a diagram of exemplary components of a mobile terminal 801 (e.g., a vehicle 111, a UE 101, or a component thereof) capable of operating in the system of FIG. 1, according to example embodiment(s). Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions that offer automatic contact matching. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile station 801 to provide a personally relevant navigation route comparison. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 851 may be, but not limited to, a single memory, CD, DVD, ROM, RAM, EEPROM, optical storage, or any other non-volatile or non-transitory storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method for providing a comparative analysis of a navigation route comprising:
determining, by a processor, an optimal navigation route;
determining a historical navigation route based on a similarity between the historical navigation route and the optimal navigation route; and
providing data for presenting one or more of the similarity or a difference between the optimal navigation route and the historical navigation route.

2. The method of claim 1, further comprising:
generating a human readable routing message indicating the similarity, the difference, the historical navigation route, or a combination thereof,
wherein the presenting includes presenting the human readable routing message.

3. The method of claim 1, further comprising:
generating a visual representation, an audio representation, or a combination thereof indicating the similarity, the difference, the historical navigation route, or a combination thereof,
wherein the presenting includes presenting the visual representation, the audio representation, or the combination thereof.

4. The method of claim 1, wherein the similarity is based on a travel distance, a travel time, or a combination thereof.

5. The method of claim 1, further comprising:
determining an additional similarity or an additional difference between the optimal navigation route and the historical navigation route; and
providing other data for presenting the additional similarity or the additional difference.

6. The method of claim 5, wherein the additional similarity is different from the similarity used as basis to determine the historical navigation route.

7. The method of claim 1, further comprising:
determining a route attribute, a contextual attribute, or a combination thereof associated with the optimal navigation route, the historical navigation route, or a combination thereof,
wherein the similarity is based on the route attribute, the contextual attribute, or a combination thereof.

8. The method of claim 7, further comprising:
selecting respective weights of the route attribute, the contextual attribute, or a combination thereof,
wherein the similarity is based on the respective weights.

9. The method of claim 7, wherein the route attribute includes a length attribute, an elevation profile attribute, a point-of-interest attribute, or a combination thereof.

10. The method of claim 7, wherein the contextual attribute includes a temporal attribute, a user activity attribute, a weather attribute, a noise level attribute, or a combination thereof.

11. The method of claim 1, wherein the determining of the historical navigation route involves selecting the historical navigation route from among a plurality of historical navigation routes that have respective similarities to the optimal navigation route, and wherein the selection is based at least on weights respectively determined for the plurality of historical navigation routes according to an amount of time between each of the plurality of historical navigation routes and the optimal navigation route.

12. The method of claim 1, further comprising:
determining one or more user accounts associated with the optimal navigation route,
wherein determining the historical navigation route is based on the historical navigation route being associated with at least one of the one or more user accounts.

13. The method of claim 1, wherein the processor executes a routing engine of a navigation system to calculate the optimal navigation route, and wherein the one or more of the similarity or the difference is presented in a user interface of the navigation system.

14. An apparatus for providing a comparative analysis of a navigation route comprising:
at least one processor; and
at least one memory including computer program code for one or more programs,
the at least one memory and the computer program code configured to, with the at least one processor, cause the apparatus to perform at least the following,
determine, by a processor, an optimal navigation route;
determine a historical navigation route based on a similarity between the historical navigation route and the optimal navigation route; and
provide data for presenting one or more of the similarity or a difference between the optimal navigation route and the historical navigation route.

15. The apparatus of claim 14, wherein the apparatus is further caused to:
generate a human readable routing message indicating the similarity, the difference, the historical navigation route, or a combination thereof,
wherein the presenting includes presenting the human readable routing message.

16. The apparatus of claim 14, wherein the apparatus is further caused to:
generate a visual representation, an audio representation, or a combination thereof indicating the similarity, the difference, the historical navigation route, or a combination thereof,
wherein the presenting includes presenting the visual representation, the audio representation, or the combination thereof.

17. The apparatus of claim 14, wherein the similarity is based on a travel distance, a travel time, or a combination thereof.

18. A non-transitory computer-readable storage medium for providing a comparative analysis of a navigation route, carrying one or more sequences of one or more instructions which, when executed by one or more processors, cause an apparatus to at least perform the following steps:
determining, by a processor, an optimal navigation route;
determining one or more user accounts associated with the optimal navigation route;
determining a historical navigation route based on a similarity between the historical navigation route and the optimal navigation route, wherein the determining of the historical navigation route is based on the historical navigation route being associated with at least one of the one or more user accounts; and
providing data for presenting one or more of the similarity or a difference between the optimal navigation route and the historical navigation route.

19. The non-transitory computer-readable storage medium of claim 18, wherein the apparatus is further caused to perform:
generating a human readable routing message indicating the similarity, the difference, the historical navigation route, or a combination thereof,
wherein the presenting includes presenting the human readable routing message.

20. The non-transitory computer-readable storage medium of claim 18, wherein the apparatus is further caused to perform:
generating a visual representation, an audio representation, or a combination thereof indicating the similarity, the difference, the historical navigation route, or a combination thereof,
wherein the presenting includes presenting the visual representation, the audio representation, or the combination thereof.
